(19) United States
(12) Patent Application Publication
(10) Pub. No.: US 2015/0170309 A1
(43) Pub. Date: Jun. 18, 2015

(54) Visual Signature Recording for Verification Purposes

(71) Applicant: Antony Diamond, Boca Raton, FL (US)

(72) Inventor: Antony Diamond, Boca Raton, FL (US)

(21) Appl. No.: 14/520,526

(22) Filed: Oct. 22, 2014

Related U.S. Application Data
(60) Provisional application No. 61/917,504, filed on Dec. 18, 2013.

(51) Int. Cl. G06Q 50/26; H04W 4/02; H04N 5/76; G06Q 10/08

(52) U.S. Cl. CPC G06Q 50/265; G06Q 10/083; H04W 4/026; H04N 5/76

(57) ABSTRACT

The present invention is generally directed to a method of capturing an identity of a party asserting an identity in a transaction receiving goods or services, including: providing a device to a signing party to receive the signature; recording a video of the signing party providing a signature on the device; and associating in a data store the video and the signature. Other aspects of the present invention may include an application or program which, when executed by one or more processors in a mobile phone, tablet computer, or delivery information acquisition device (“DIAD”), cause the performance of the steps: recording an image of a party asserting an identity; recording a video of the signing party providing a signature; capturing the time and date; determining the location; and associating in a data store the image, video, signature, time and date, and location.

### RELATED APPLICATIONS

This application claims priority to U.S. Provisional Patent Application No. 61/917,504, filed on Dec. 18, 2013, which is incorporated herein by reference in its entirety.

### BACKGROUND

In general, the present invention is directed to methods of capturing an identity of a party signing for a financial transaction or receiving delivery of goods or services, and software applications therefor. More specifically, the present invention is directed to methods of utilizing video, picture, or image recording applications in mobile computing devices to record a party signing for such transaction or delivery during the act of signing.

A user signature is often used for authentication purposes. For example, when conducting a purchase transaction using a credit or debit instrument—or a check or draft—a party is often required to provide a signature. Signatures should be compared to a signature card in order to verify the identity of the signer, but such comparisons are often not made. Indeed, comparisons to verified signatures are often only performed after some other indication or sign of a fraudulent transaction.

Many types of transactions may be based on or require a signature. For example, with the creation and expansion of the internet and mobile computing devices, remote transactions are becoming more and more commonplace. Such remote transactions may include one or more events that may require an authentication. For example, when payment information is provided—for example, via the Internet or a web interface—a user may be attesting or submitting that he or she is authorized to provide the payment information. Moreover, upon delivery of goods or services purchased in a remote transaction a user may be required to provide an additional signature. The signature may be required to complete the financial transaction or may be required to confirm authorization to accept delivery. In the case of delivery, it is often desirable to confirm that the party receiving the goods or services purchased in a remote transaction is authorized to receive the goods or services—perhaps by being the same party, or an authorized recipient (such as, for example, one receiving a gift).

Certain debit and/or credit instruments may contain a picture of the account holder thereon, so that a party requiring a signature may verify the identity of the signer not only based upon the signature, but also his or her visual identity. However, such picture is generally not conveyed to one receiving a signature at a remote location. Accordingly, a means or method to compare the visual identify of a party providing a signature at a remote location with a visual indication of a party authorized to make a financial transaction is desirable.

Additionally, various mobile devices are now used to perform financial transactions and capture signatures. For example, tablet computers (such as an iPad, Kindle, Nook, Surface, and/or any other type of tablet computer) and mobile phones may be used to initiate and perform financial transactions or record signatures upon delivery of goods or services. Such transactions may be performed using various programs, applications, or apps, or through the use of additional external devices such as, but not limited to, Square, PayPal Here, GoPayment, PayAnyWhere, Mobile Pay on Demand, Paydiant, etc. Such tablet computers and mobile phones are often equipped with one or more cameras. Accordingly, it is desirable to use the camera and video, picture, and/or image recording capability of such devices to record a party signing, for example a transaction document or a delivery receipt. Moreover, in the cases where such devices are used to capture the signature itself, a front facing or rear facing camera may record the signing party during the signing process, and verification may be made between the input received by the signing and the video, picture, and/or image recorded of the process. Such video, picture, and/or image may be recorded and provided to the party requesting or requiring the signature.

For example, if a merchant ships a product and the product is signed for at delivery, the merchant may receive a video, picture, and/or pictures of the party that signed for the product. Such video, picture, image, and/or pictures may be used for any number of reasons, including but not limited to: identifying a party that may have fraudulently received the goods or services, or confirming that a party actually received the goods or services (which may useful if a party is attempting to claim that they did not receive the goods or services, and is therefore requesting a refund).

### SUMMARY OF THE INVENTION

Aspects of the invention may include a method of capturing an identity of a party asserting an identity in a transaction receiving goods or services, comprising: providing a device to a signing party to receive the signature of the signing party; recording a video, picture and/or image of the signing party providing a signature on the device; and associating in a data store the video, picture, and/or image and the signature.

Other aspects in accordance with some embodiments of the present invention may include an application or program which, when executed by one or more processors in a mobile phone, tablet computer, or delivery information acquisition device (“DIAD”), cause the performance of the method comprising: recording an image of a party asserting an identity in a transaction receiving goods or services; recording a video, picture, and/or image of the signing party providing a signature on the device; capturing the time and date of the signing party providing the signature; determining the location of the signing party providing the signature; and associating in a data store the video, picture, and/or image, signature, time and date, and the location.

Other aspects in accordance with some embodiments of the present invention may include a method of confirming and capturing an identity of a party asserting an identity in a transaction receiving goods or services, comprising: identifying one or more authorized signing parties; displaying on the device, if available, a past image of the one or more authorized signing parties; upon receipt of confirmation that the signing party matches the past image, providing interface for receiving signature of signing party into device; recording a video, picture, and/or image of the signing party providing a signature on the device; and associating in a data store the video, picture, and/or image and the signature.

These and other aspects will become apparent from the following description of the invention taken in conjunction with the following drawings, although variations and modifications may be effected without departing from the spirit and scope of the novel concepts of the invention.

### BRIEF DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary electronic device that may be used to capture a recipient's signature and a picture and/or video of the recipient signing for an item, in accordance with some embodiments of the present invention.

FIG. 2 illustrates an exemplary electronic device that may be used to capture a recipient's signature and a video, picture, and/or image of the recipient signing for an item, in accordance with some embodiments of the present invention.

FIG. 3 illustrates an exemplary method and/or process in which a video, picture, and/or image of a signature is captured, in accordance with some embodiments of the present invention.

FIG. 4 illustrates an exemplary method and/or process in which a video, picture, and/or image of a signature is captured along with inputs of a signature, in accordance with some embodiments of the present invention.

FIG. 5 depicts a graphical capture from a file that may be prepared in accordance with some embodiments of the present invention.

FIG. 6A-6D illustrates various pieces of information that may be collected in accordance with some embodiments of the present invention.

FIG. 7 depicts a graphical presentation of information that may be collected in accordance with some embodiments of the present invention.

FIG. 8 illustrates an exemplary method and/or process in which a video, picture, and/or image of a signature is captured and compared with a past video, picture, and/or image used for authentication, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

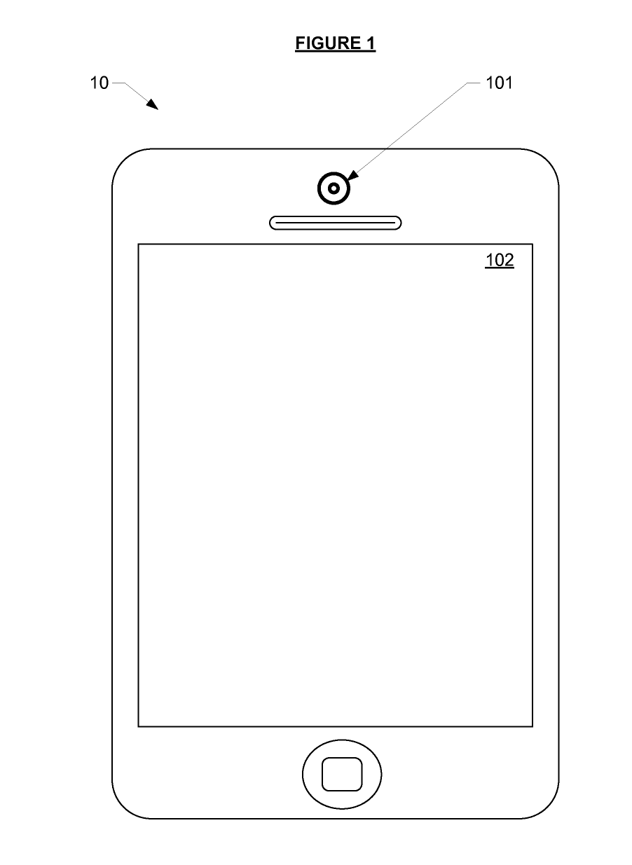

With reference to FIG. 1, an exemplary electronic device 10 that may be used in accordance with the systems and methods of the present invention. Device 10 may comprise a front-facing camera 101 that may be used, as discussed in greater detail below, to capture an image and/or video of the signer and/or the act of signing. Device 10 may further comprise an input portion 102 that may be used to receive a signature of the signer. As discussed below, this signature may be married or merged with the video, picture, and/or image of the act of signing.

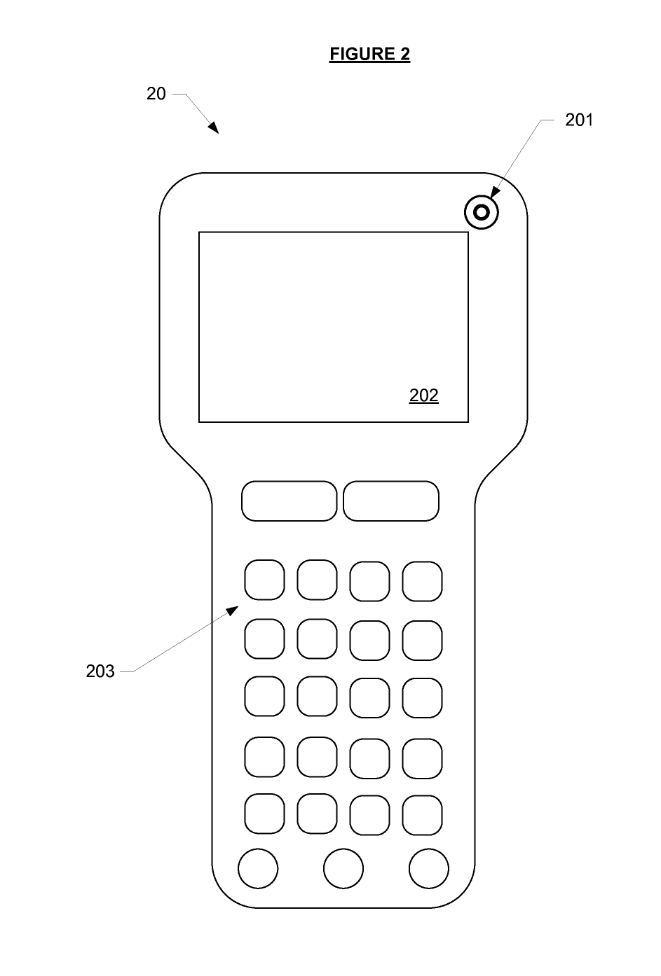

Similar to FIG. 1, FIG. 2 depicts an exemplary electronic device 20, which may also comprise a camera 201 (which may be forward-facing or rear-facing) and one or more input portions 202, 203. As noted above, the camera 201 may be used to record a video, picture, and/or image of a signer and/or the act of signing, and may associate this information with the received signature.

It is also contemplated by the present invention that more than one device may be used. For example, a signature may be captured on a device such as that shown in FIG. 1 or 2, while a video, picture, and/or image of the signer and/or the act of signing may be captured on a second device. These images may be associated with each other through the use of software, an application (or “app”) so that the joint information may be saved together.

For example, a rear facing camera on a tablet, phone, PDA, etc. may be used so that the camera is facing the signing party. In this manner, the signing party can see the image of himself or herself during the signing action, and can position the camera and/or himself or herself such that his/her face is visible in the camera. The device may accordingly capture both the signature and the video, picture, and/or image of the signing party.

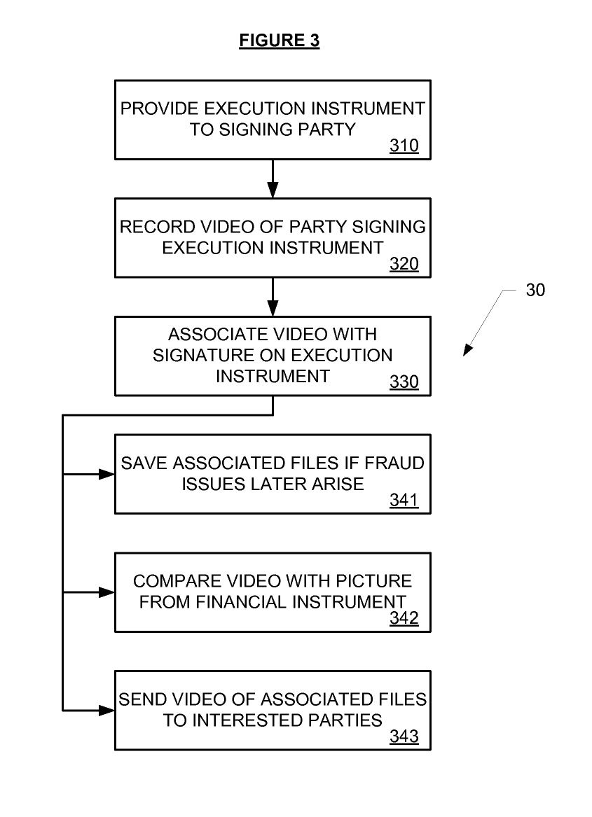

With reference to FIG. 3, an exemplary method and/or process 30 in which a video, picture, or pictures of a signature is captured, in accordance with some embodiments of the present invention will now be discussed. At 310 an execution instrument may be provided to a signing party. The execution instrument may be a physical document or item (such as a contract, delivery confirmation, receipt, financial authorization, etc.), or may be an electronic device or item (such as a delivery confirmation device such as those used by UPS or FedEx delivery, a mobile computing device such as a tablet computer or smart phone, a digital terminal at a point of sale, etc.). The party providing the execution instrument to the signing party may be a party to the transaction (such as a merchant or seller of goods or services), or may be peripheral to the transaction (such as a delivery person).

At 320 the signing party may sign or execute the execution instrument, during which the signing process may be recorded. The signing process may be recorded by any type of video recorder, although it is contemplated that the recordation may be captured by a mobile computing device such as a tablet computer or smart phone, or by a delivery confirmation device, such as those utilized by UPS and/or FedEx. A video, picture, and or image may be captured, or a series of pictures of the signer, the actual signature, etc.

At 330 the video, picture, and/or image of the signing process captured at 320 may be associated with the signature itself. In the case of a digital signature captured on an electronic device or item (as noted above), such files may be associated or otherwise “married.” In the case of a traditional signature—such as using paper and an ink or lead-based writing instrument, the picture, scan, or other capture of the signature may be performed and associated with the video, picture, and/or image.

The combination of the signature and video, picture, and/or image may be used for any number of purposes. For example, at 341 the combination may merely be saved in case of any later issues—such as allegations of fraud, improper or non-delivery, etc.

At 342, further processing may be performed. For example, if a good or service was purchased using a credit instrument that is associated with a picture (such as certain credit or debit instruments that include a user's picture or photo thereon), such picture may be compared with the video, picture, and/or image of the signing party to confirm identity. For example, such confirmation may be made by the party requesting the signature (by providing the party requesting the signature with the photo associated with the payment instrument), or may be made by a financial transaction processor at a later time.

At 343 the combination of the signature and the video, picture, and/or image of the signing process may be sent to the seller or merchant, the delivery service, a financial processor, insurer of the goods or services (or insurer to the merchant, delivery service, or recipient), etc. It is contemplated by the present invention that such parties may receive such combination of signature and the video, picture, and/or image in real time, near-real time, or through periodic or batch up-loads.

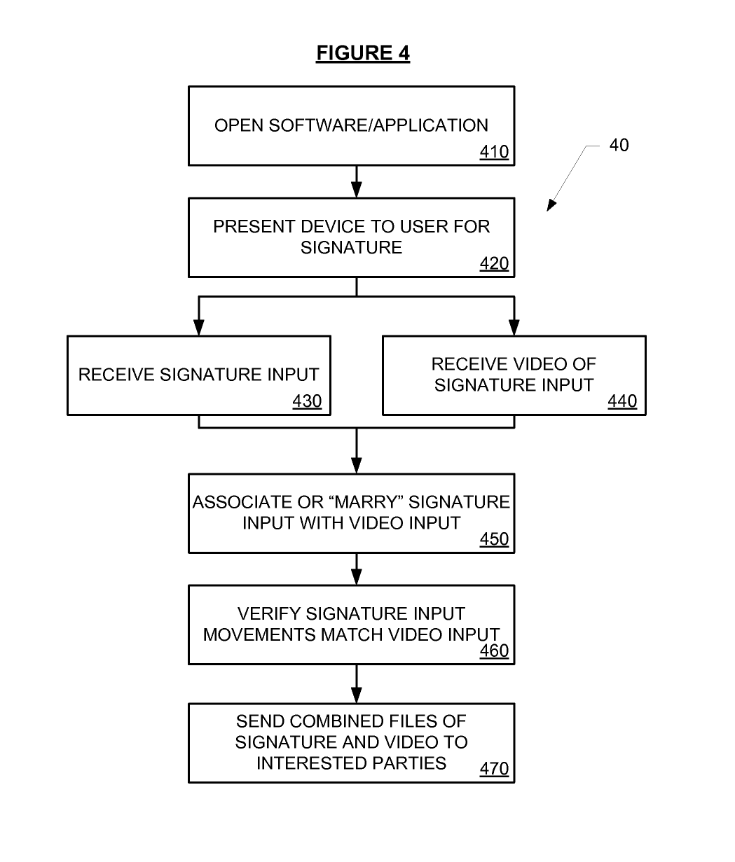

With reference to FIG. 4, an exemplary method and/or process 40 in which a video, picture, and/or image of a signature is captured along with inputs of a signature, in accordance with some embodiments of the present invention will now be discussed. The method and/or process 40 may be performed with a device that captures a digital signature. Such devices may be a digital point of sale terminal, a tablet computer, a smart phone, a delivery confirmation device, etc. At 410, a program, application, or app may be opened on the device. Such program, application, or app may control receiving one or more inputs of the signing process into the device.

At 420, the signing party may input their signature. At 430 the device may receive the digital input. Such input may be received, for example, by capturing the input of a stylus or digital pen on a screen of the device. Alternatively, in the case of a touch screen device, the device may capture physical touching of the screen as a provided signature.

Simultaneous to 430, at 440 the device may record a video, picture, and/or image of the signing. For example, if the signature is provided to a tablet computer or smart phone, the signature may be received on the display, while a rear-facing camera may capture video, picture, or pictures of the actual signing process.

At 450 the input of the signature and the input of the video, picture, and/or image of the signing process may be associated with each other or “married.” In accordance with some embodiments of the present invention (though not required), further processing may be conducted on the associated files. For example, algorithms may be run to confirm that the visual inputs received by the camera match the digital or tactile inputs received in the signature. Confirming the relation of both files may create a high confidence of association should the image, signature, or association there between be later challenged.

Note that while FIG. 4 is discussed with regard to receiving both inputs in a single device, it is contemplated that the inputs may be received by different devices and associated or “married” subsequent to execution. For example, a signing party may execute a signature on a delivery confirmation device while the signing process is recorded with a mobile computing device or any other type of device with video recording capability. The movements of the party signing—including but not limited to the hand movements of the party—may be time stamped and married to the signature file. Again, though not required, various processing can be conducted to such files to show that the video, picture, and/or image file and the signature file are of the same transaction.

At 470 the combination of the signature and the video, picture, and/or image of the signing process may be sent to interested parties, including but not limited to: a seller or merchant, a delivery party, a buyer, a financial processor (particularly if the signature is for a financial transaction), or insurer.

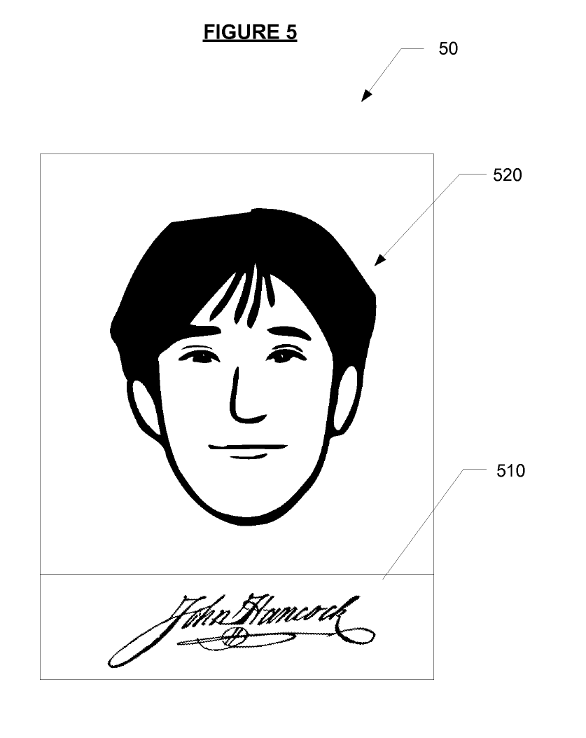

FIG. 5 illustrates a graphical representation 50 of information that may be captured in accordance with the systems and methods of the present invention. A signature of the signer 510 may be saved and associated with a video, picture, and or image 520 of the signer creating the saved signature.

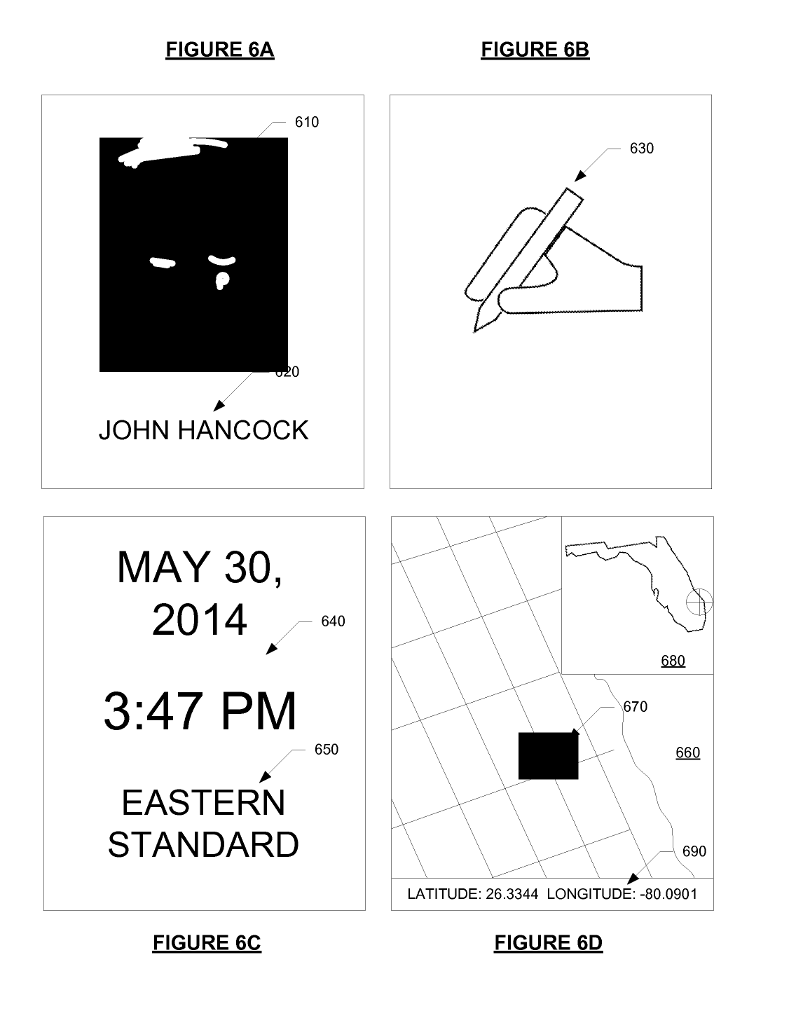

With reference to FIGS. 6A-6D, information that may be captured and associated in accordance with systems and methods of the present invention will now be discussed. At 6A, an image 610 of the signer may be saved, associated with the name of the signer 620. At 6B a video, picture, and/or image 630 of the signer signing the device may be saved. At 6C, information may include a date and time of execution or signing 640—depicted as “May 30, 2014, 3:47 PM,” as well as the time zone of such time of execution or signing 650—shown as “Eastern Standard.”

At 6D, a map 660 may be saved which may set forth the location of execution or signing. The map 660 may show the address of signing 670, as well as an inset 680 showing the greater geographic area. Moreover, map 660 may further include the longitude and latitude setting forth the specific geographic location in which the signing or execution occurred.

Each of the information related to the signing—the name of the signer, an image of the signer (potentially obtained from a publically accessible database, or alternatively obtained before the signature is received), a video of the act of signing, the date and time of signing, the signature itself, the location of signing, and/or a list of the items and/or products signed for by the signer.

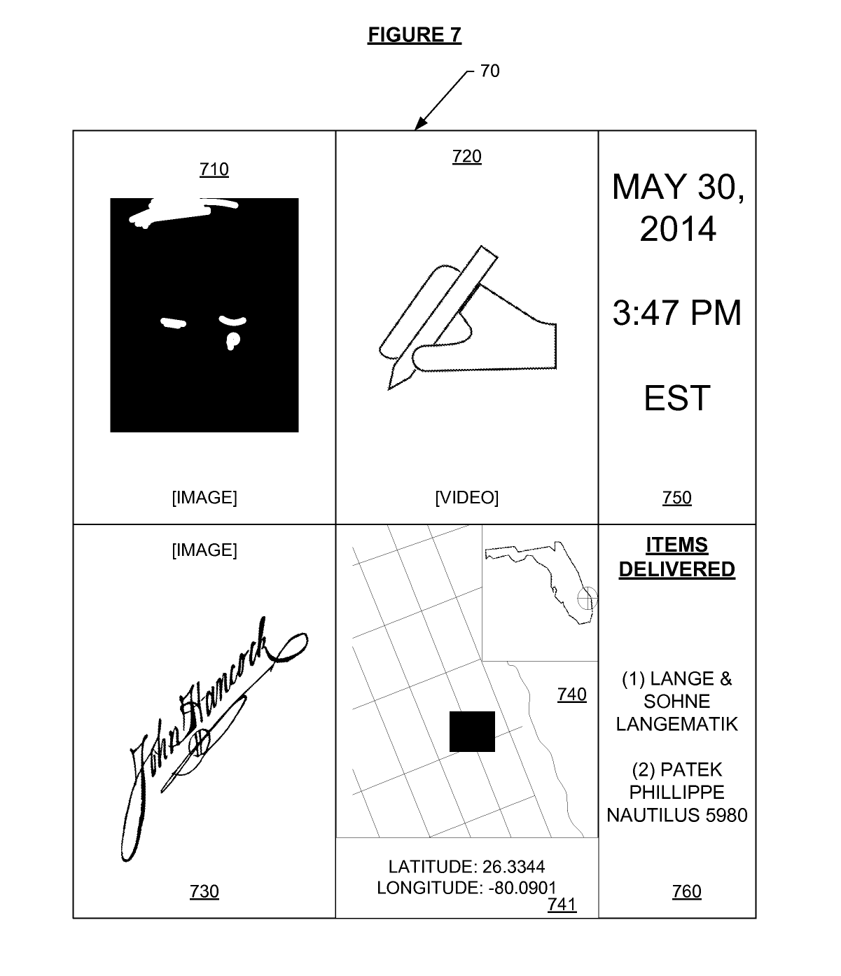

With reference to FIG. 7, such information may be graphically presented in a single presentation, or dashboard 70. Such dashboard may be compiled at the time of signing on the device, or may be saved at a central location if the delivery, validity of signature, or any other issues may arise a later time. Dashboard 70 may illustrate an image of the signer 710, a video, picture, and/or image of the act of signing 720, an image of the signature as received by the device 730, information regarding the location of the signing, which may be presented in graphical format 740 or by longitude and latitude 741. Dashboard 70 may further illustrate the date and time of signing (including time zone) 750, and information regarding the products or items 760 delivered and/or signed for by the signer.

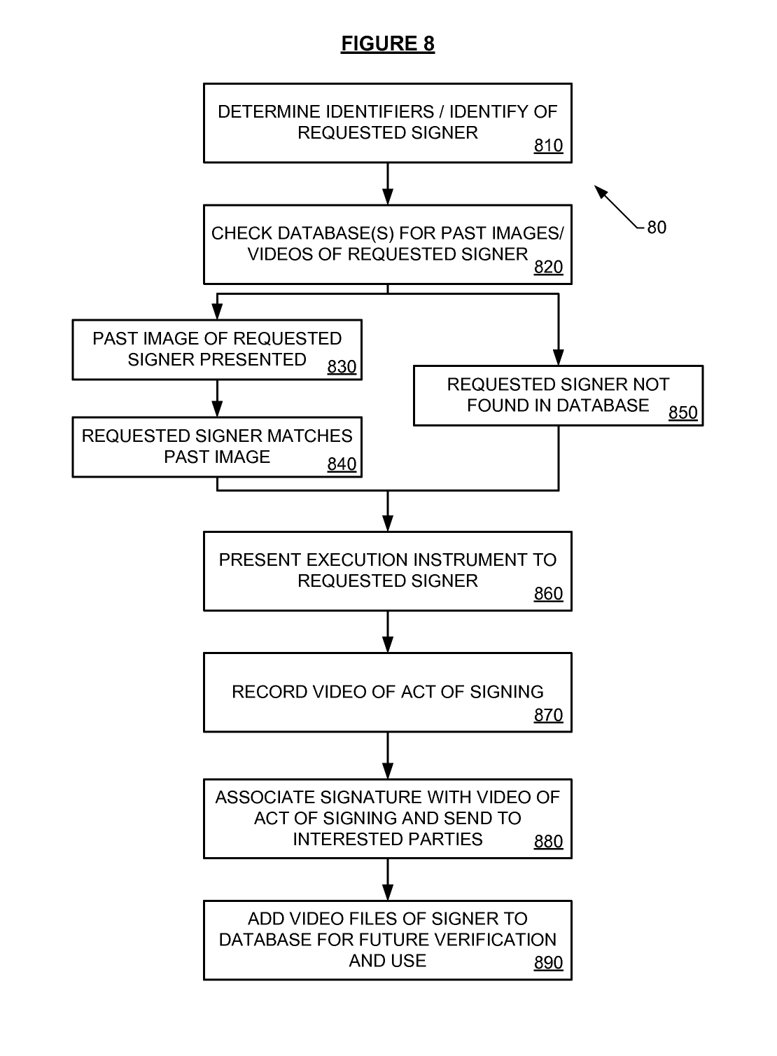

With reference to FIG. 8 an exemplary method and/or process 80 in which a video, picture, and/or image of a signature is captured and compared with past videos used for authentication, in accordance with some embodiments of the present invention, will now be discussed. At 810 the identity of the required signer is determined. Such identity may be based upon any information sufficient to identify the signer. For example, such identity determination may be based on the signer's name, financial account number used in the underlying transaction, delivery address, log-on name or password, membership account information, etc.

At 820 a database or data store may be queried to determine if there any past photographs or videos of the signer. Such database or data store may include, but not limited to, photographs stored by financial processors who place photographs on transaction cards, previously recorded photographs or videos of signing or execution processes, publicly available databases (for example, by pulling photos from social media such as FaceBook or LinkedIn), and/or web camera captures that may be captured during a purchase transaction.

At 830 a past photograph or video of the signing party may be identified, and may be presented to the party requiring the signature. For example, a delivery person may receive a photograph of the person that is supposed to sign for the item. At 840 a determination may be made if the person is identified to be or likely to be the appropriate party. If not, the transaction may terminate. If so, at 860 the execution instrument may be presented to the party for his or her signature.

Alternatively, a database may be queried to identify a picture of the anticipated signer, and the facial recognition algorithms and/or methods may be applied in order to determine if the signer is the same party as that identified by the picture. Such facial recognition ability and/or software may be locally processed at the device, or may be remotely processed and a determination may be returned to the device. In this manner, decision-making (and accordingly, potential liability) may be removed from the delivery person.

Alternatively, if there are no past photographs or videos of the signing party at 850, the process may jump to step 860 and the signer may be presented with the execution instrument. At 870, much as discussed above, the act of signing may be captured by at least video, picture, and/or image, and may be associated with the signature at 880 (whether the signature was received digitally or otherwise) and the associated files may be saved and or sent to interested parties (again, for example, a seller or merchant, a delivery party, a buyer, a financial processor (particularly if the signature is for a financial transaction), or insurer).

At 890 the video, picture, and/or image files may be added to a database or data store so that future transactions may have video, picture, or pictures files to confirm the identity of the party signing before presenting the party with the execution instrument.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

What is claimed is:

1. A method of capturing an identity of a party asserting an identity in a transaction receiving goods or services, comprising:
providing a device to a signing party to receive the signature of the signing party;
recording a video of the signing party providing a signature on the device;
associating in a data store the video and the signature.

2. The method of claim 1, further comprising verifying by a processor that the signature matches movements recorded in the video.

3. The method of claim 1, further comprising capturing an image of the signing party before the act of providing a signature on the instrument or device.

4. The method of claim 1, further comprising capturing the date and time of the signing party providing the signature.

5. The method of claim 1, further comprising determining and saving the location of the signing party providing the signature.

6. The method of claim 5, wherein the location is saved as a combination of latitude and longitude.

7. The method of claim 1, wherein the device receives the signature and captures the video using a rear facing camera.

8. The method of claim 1, wherein the device receives the signature and a second device records the video.

9. The method of claim 1, wherein the device is selected from the group consisting of a mobile phone, personal digital assistant, tablet computing device, laptop computing device, and digital kiosk.

10. The method of claim 1, wherein the device is a delivery information acquisition device.

11. An application or program which, when executed by one or more processors in a mobile phone, tablet computer, or delivery information acquisition device (“DIAD”), cause the performance of the method comprising:
recording an image of a party asserting an identity in a transaction receiving goods or services;
recording a video of the signing party providing a signature on the device;
capturing the time and date of the signing party providing the signature;
determining the location of the signing party providing the signature; and
associating in a data store the image, video, signature, time and date, and the location.

12. The application or program of claim 11, wherein the location is determined based upon the latitude and longitude of the mobile phone, tablet computer, or DIAD.

13. A method of confirming and capturing an identity of a party asserting an identity in a transaction receiving goods or services, comprising:
identifying one or more authorized signing parties;
displaying on the device, if available, a past image of the one or more authorized signing parties;
upon receipt of confirmation that the signing party matches the past image, providing interface for receiving signature of signing party into device;
recording a video of the signing party providing a signature on the device;
associating in a data store the video and the signature.

14. The method of claim 13, further comprising:
capturing image of signing party.

15. The method of claim 13, further comprising:
capturing the time and date of the signing party providing the signature on the device.

16. The method of claim 13, further comprising:
determining location of the signing party providing the signature on the device.

17. The method of claim 13, further comprising verifying by a processor that the signature matches movements recorded in the video.

18. The method of claim 13, wherein the past image is obtained from a publicly accessible database.

19. The method of claim 13, wherein the past image was submitted during a purchase transaction of the goods or services.

20. The method of claim 13, wherein the signature is received in a first device and the video is recorded on a second device.
